(19) United States
(12) Patent Application Publication
(10) Pub. No.: US 2026/0366355 A1
(43) Pub. Date: Nov. 19, 2026

(54) WINDOW REGULATOR

(71) Applicant: Johnan Manufacturing Inc., Ueda-shi (JP)

(72) Inventor: Akira WAKABAYASHI, Ueda-shi (JP)

(73) Assignee: Johnan Manufacturing Inc., Ueda-shi (JP)

(21) Appl. No.: 19/669,150

(22) Filed: May 6, 2026

(30) Foreign Application Priority Data
May 19, 2025 (JP) 2025-083665

(51) Int. Cl. E05F 15/689

(52) U.S. Cl. CPC E05F 15/6911; E05Y 2201/64; E05Y 2900/55

(57) ABSTRACT

A window regulator includes a carrier plate that supports a window glass, a wire to pull the carrier plate, and a slack removal mechanism that is arranged on the carrier plate and absorbs slack of the wire by moving one end of the wire. The slack removal mechanism includes a ratchet member that is attached to the carrier plate and includes ratchet teeth formed thereon, a movable-side member that is coupled to one end of the wire and is housed so as to be movable relative to the carrier plate while engaging the ratchet teeth, and a biasing portion to bias the movable-side member in a sliding direction of the ratchet teeth. The ratchet member is configured to be attachable to the carrier plate by inserting in a direction opposite to the sliding direction.

### CROSS-REFERENCE TO RELATED APPLICATIONS

The present patent application claims the priority of Japanese patent application No. 2025/083665 filed on May 19, 2025, and the entire contents of Japanese patent application No. 2025/083665 are hereby incorporated by reference.

### TECHNICAL FIELD

The present invention relates to a window regulator.

### BACKGROUND ART

A window regulator is known which includes a slack removal mechanism to eliminate slack of a wire (see Patent Literature 1). The wind regulator includes a guide rail, a carrier plate, a motor unit and a wire, and a slack removal mechanism arranged on the carrier plate to absorb slack of the wire. The slack removal mechanism includes a ratchet member on the fixed side (a fixed-side ratchet member) that is fixed to the carrier plate and has a row of fixed-side claws, a member on the movable side (a movable-side ratchet member) that is coupled to one end of the wire and has a row of movable-side claws to be locked to the row of fixed-side claws, and a compression coil spring that biases the movable-side member. In the window regulator, when the wire is slacked, the position of engagement between the row of fixed-side claws and the row of movable-side claws changes due to a biasing force of the compression coil spring, allowing the slack of the wire to be absorbed.

### CITATION LIST

### Patent Literature

Patent Literature 1: JP 2001/336350

### SUMMARY OF INVENTION

However, during assembly work of the window regulator, after the movable-side member is attached to the carrier plate until attachment of the wire is complete, it is necessary to compress the coil spring. Therefore, there is a problem of poor ease of assembly.

It is an object of the invention to provide a window regulator that can improve ease of assembly of the window regulator.

An aspect of the invention provides a window regulator, comprising:
a. a carrier plate that supports a window glass;
b. a wire to pull the carrier plate; and
c. a slack removal mechanism that is arranged on the carrier plate and absorbs slack of the wire by moving one end of the wire,
d. wherein the slack removal mechanism comprises a ratchet member that is attached to the carrier plate and comprises ratchet teeth formed thereon, a movable-side member that is coupled to one end of the wire and is housed so as to be movable relative to the carrier plate while engaging the ratchet teeth, and a biasing portion to bias the movable-side member in a sliding direction of the ratchet teeth, and
e. wherein the ratchet member is configured to be attachable to the carrier plate by inserting in a direction opposite to the sliding direction.

### Advantageous Effects of Invention

A window regulator according to an exemplary embodiment of the invention can improve ease of assembly.

### BRIEF DESCRIPTION OF DRAWINGS

FIG. 1 is a general schematic diagram illustrating a window regulator in an embodiment of the present invention and a vehicle door on which the window regulator is provided.

FIG. 2A is a front view showing the window regulator when a window glass is fully closed.

FIG. 2B is a front view showing the window regulator when the window glass is fully open.

FIG. 3A is a front view showing a carrier plate.

FIG. 3B is a plan view showing the carrier plate.

FIG. 3C is a rear view showing the carrier plate.

FIG. 4 is a cross-sectional view showing a descending-side wire attachment portion taken along line A-A’ in FIG. 3B.

FIG. 5 is an exploded perspective view showing the descending-side wire attachment portion.

FIG. 6A is a perspective view showing a plug.

FIG. 6B is a front view showing the plug.

FIG. 6C is a plan view showing the plug.

FIG. 6D is a right side view showing the plug.

FIG. 7A is a perspective view showing a pair of racks.

FIG. 7B is a front view showing the pair of racks.

FIG. 7C is a bottom view showing the pair of racks.

FIGS. 8A - 8C are explanatory diagrams illustrating an operation of assembling the window regulator.

FIGS. 9A - 9C are explanatory diagrams illustrating a mechanism housing portion and therearound during the operation of assembling the window regulator.

FIG. 10A is a diagram illustrating the first modification of the descending-side wire attachment portion.

FIG. 10B is a diagram illustrating the second modification of the descending-side wire attachment portion.

### DESCRIPTION OF EMBODIMENTS

A window regulator in an embodiment of the invention will be described below with reference to the appended drawings. This window regulator is a raising/lowering device that is installed in a vehicle door provided on a vehicle (e.g., an automobile) and raises/lowers a window glass on the vehicle door. In particular, this window regulator is designed to improve ease of assembly of the slack removal mechanism which absorbs slack of a descending-side wire. Hereinafter, an ascending/descending direction of the window glass will be simply referred to as the ascending/descending direction. In addition, left, right, front, rear, up and down used in the following description are as defined in each drawing. In the present embodiment, a vehicle width direction coincides with a front-rear direction of the window regulator.

### Configuration of the window regulator

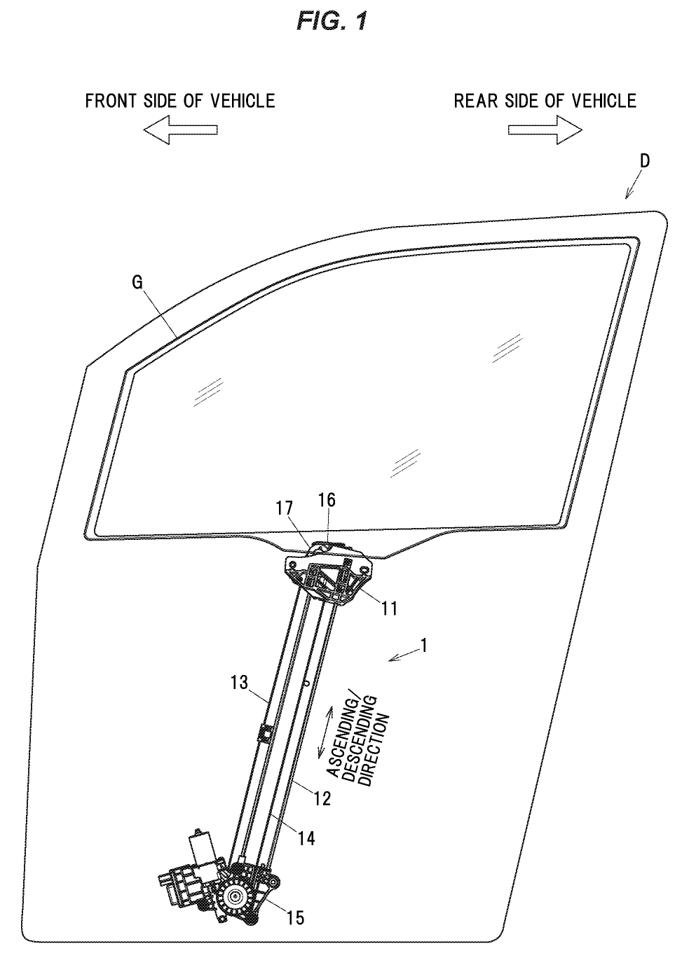

As shown in FIGS. 1 - 2A, a window regulator 1 is installed on a vehicle door D and includes a carrier plate 11 that supports a window glass G, a guide rail 12 that supports the carrier plate 11 so as to be slidable in the ascending/descending direction, an ascending-side wire 13 and a descending-side wire 14 that pull the carrier plate 11, a drive unit 15 that is arranged at a lower end portion of the guide rail 12 to drive the ascending-side wire 13 and the descending-side wire 14, and a pulley 17 that is provided at an upper end portion of the guide rail 12 through a pulley bracket 16 and changes the direction of the ascending-side wire 13. That is, this window regulator 1 is a wire driving-type window regulator to raise and lower the carrier plate 11 using the wires 13, 14 and is also a lower end drive-type window regulator having the drive unit 15 arranged at a lower end portion of the guide rail 12.

As shown in FIG. 1, the guide rail 12 is formed by bending a long metal plate so as to be curved toward the outside of a vehicle cabin at a predetermined curvature, and is arranged so as to tilt to the rear side in a vehicle front-rear direction with respect to the vehicle door D. Then, the guide rail 12 extends in the ascending/descending direction of the window glass G and supports the carrier plate 11 so as to be slidable in the ascending/descending direction.

The ascending-side wire 13 is coupled at one end to a rotating drum 22 (described later) of the drive unit 15, is fed upward from the drive unit 15 to the pulley 17, is redirected downward by the pulley 17, and is then attached at the other end to the carrier plate 11. Then, the descending-side wire 14 is coupled at one end to the rotating drum 22 of the drive unit 15, is fed upward from the drive unit 15, and is attached at the other end to the carrier plate 11.

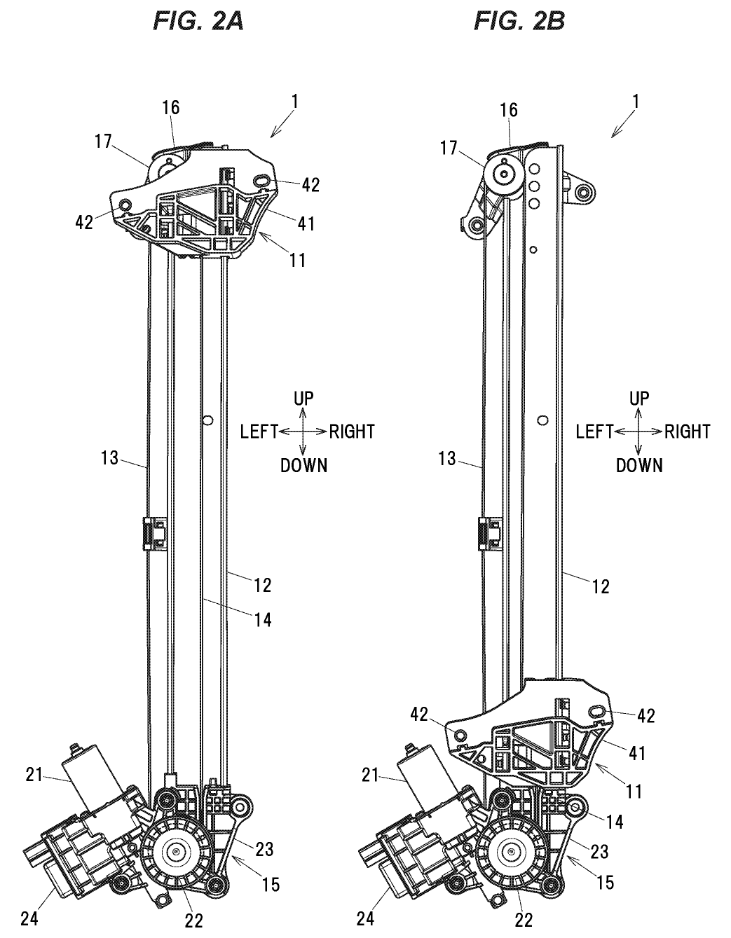

As shown in FIGS. 2A and 2B, the drive unit 15 has a reversible motor 21, the rotating drum 22 that is rotationally driven by the motor 21 and rotates to take up and feed out the ascending-side wire 13 and the descending-side wire 14, a reducer (not shown) to transfer rotation of the motor 21 to the rotating drum 22, a drum housing 23 to which the lower end portion of the guide rail 12 is fitted and in which the rotating drum 22 is rotatably housed, and a motor housing 24 holding the motor 21. The motor housing 24 incorporates the reducer and is fixed to the drum housing 23 so as to cover a drum housing portion of the drum housing 23.

When the motor 21 is driven in forward, the rotating drum 22 rotates in the forward direction and accordingly takes up the ascending-side wire 13 while feeding out the descending-side wire 14. Thus, the carrier plate 11 is pulled by the ascending-side wire 13 and moves upward in the ascending/descending direction. As a result, the window glass G attached to the carrier plate 11 is raised. On the other hand, when the motor 21 is driven in reverse, the rotating drum 22 rotates in the reverse direction and accordingly takes up the descending-side wire 14 while feeding out the ascending-side wire 13. Thus, the carrier plate 11 is pulled by the descending-side wire 14 and moves downward in the ascending/descending direction. As a result, the window glass G attached to the carrier plate 11 is lowered. In this manner, the carrier plate 11 and the window glass G are raised and lowered along the guide rail 12 (operations of raising and lowering the window glass G).

### Configuration of the carrier plate

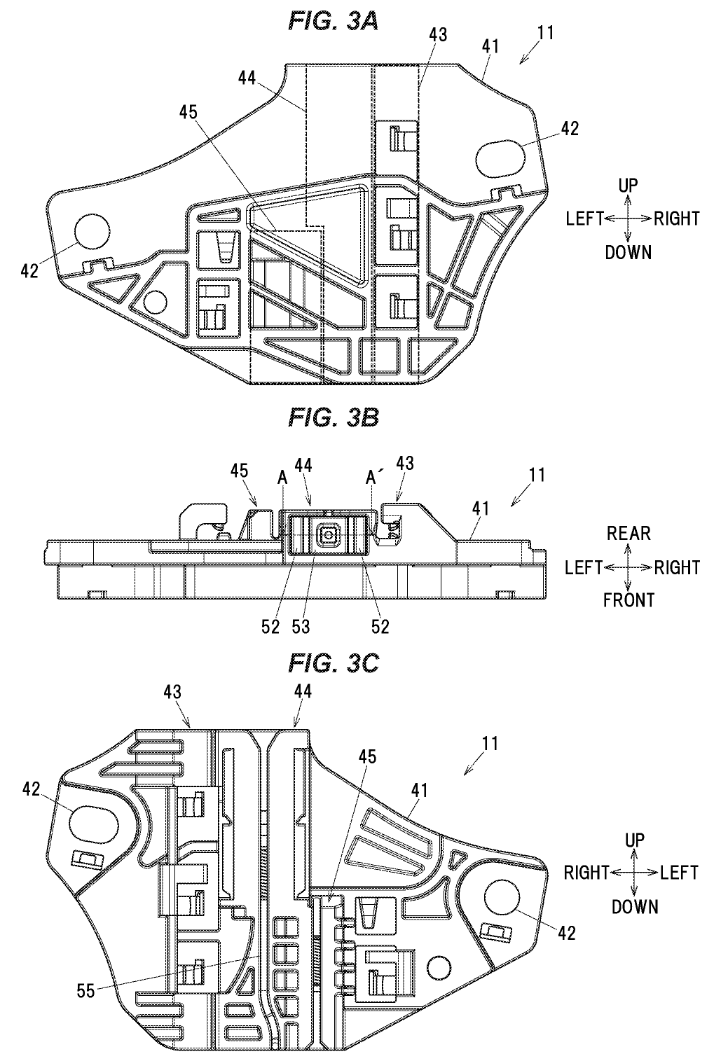

Next, the carrier plate 11 will be described with reference to FIGS. 3A - 7C. As shown in FIGS. 3A - 3C, the carrier plate 11 is formed of a resin (e.g., polyacetal), and has a plate-shaped main body 41, two attachment hole 42, 42 formed at right and left end portions of the main body 41, a rail sliding portion 43 formed on the rear surface of the main body 41 on the slightly right side of the center, a descending-side wire attachment portion 44 formed (arranged) on the main body 41 on the left of the rail sliding portion 43, and an ascending-side wire attachment portion 45 formed on the main body 41 on the left of the descending-side wire attachment portion 44. The descending-side wire attachment portion 44 employs a slack removal mechanism that absorbs slack of the descending-side wire 14, and the descending-side wire attachment portion 44 is an example of the “slack removal mechanism”.

The attachment holes 42, 42 are for bolt-fastening glass holders (not shown) that are fixed to the window glass G. The window glass G is attached to the carrier plate 11 through the glass holders by fastening the glass holders to the attachment holes 42, 42 with bolts.

The rail sliding portion 43 slides against a right-side plate portion of the guide rail 12. That is, sliding of the rail sliding portion 43 against the right-side plate portion of the guide rail 12 allows the carrier plate 11 to be slidably supported on the guide rail 12.

One end of the ascending-side wire 13 is attached to the ascending-side wire attachment portion 45. That is, the carrier plate 11 is configured to be pulled upward in the ascending/descending direction by the ascending-side wire 13 through the ascending-side wire attachment portion 45.

### Configuration of the descending-side wire attachment portion

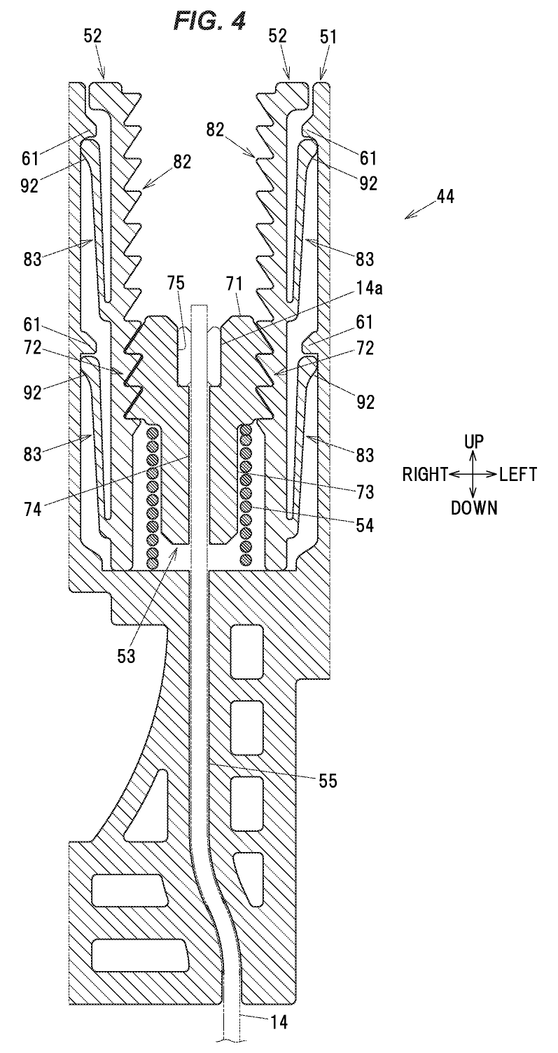

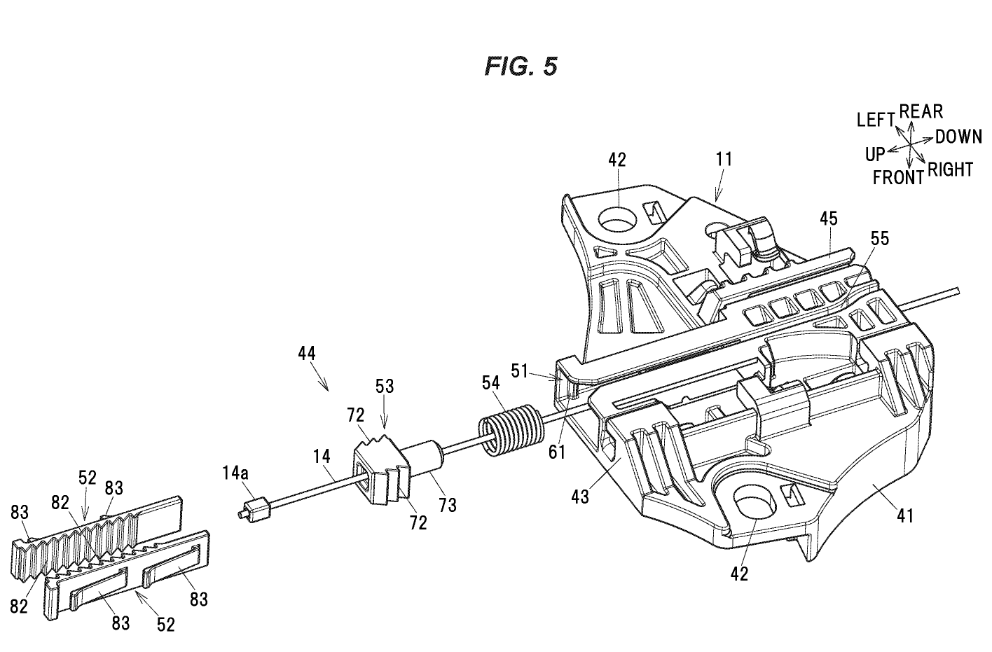

As shown in FIGS. 4 and 5, the descending-side wire attachment portion 44 has a function of a slack removal mechanism that absorbs slack of the descending-side wire 14 by moving one end of the descending-side wire 14, and has a mechanism housing portion 51 formed on the main body 41, a pair of fixed-side racks 52, 52 which are attached to the mechanism housing portion 51 and have ratchet teeth 82 formed thereon, a movable-side plug 53 that is coupled to the one end of the descending-side wire 14 and movably housed in the mechanism housing portion 51 while engaged with the ratchet teeth 82 of the pair of racks 52, 52, a biasing spring 54 to bias the plug 53 upward, and a wire lead-out groove 55 extending from the mechanism housing portion 51 to the lower surface of the main body 41 to lead the descending-side wire 14, which is fixed to the plug 53, to the outside of the carrier plate 11. The rack 52 is an example of the “ratchet member”, and the plug 53 is an example of the “movable-side member”. The biasing spring 54 is an example of the “biasing portion”.

The mechanism housing portion 51 is formed in a box shape opening on the upper side, and houses the pair of racks 52, 52, the plug 53 and the biasing spring 54. In detail, as shown in FIG. 4, each of the right inner wall and left inner wall of the mechanism housing portion 51 has two upper and lower locking protrusions 61, 61, and the pair of racks 52, 52 are attached to the mechanism housing portion 51 by plate spring portions 83 (described later) of the racks 52 locked to the locking protrusions 61, 61. In addition, the plug 53 is housed between the pair of racks 52, 52 so as to be movable in the up-down direction relative to the mechanism housing portion 51. Furthermore, the biasing spring 54 is housed between the plug 53 and the bottom wall of the mechanism housing portion 51. Each of the locking protrusions 61, 61 is preferably configured such that a lower surface is a surface parallel to the left-right and front-rear directions while an upper surface is an inclined surface that slopes inward in the left-right direction from above to below.

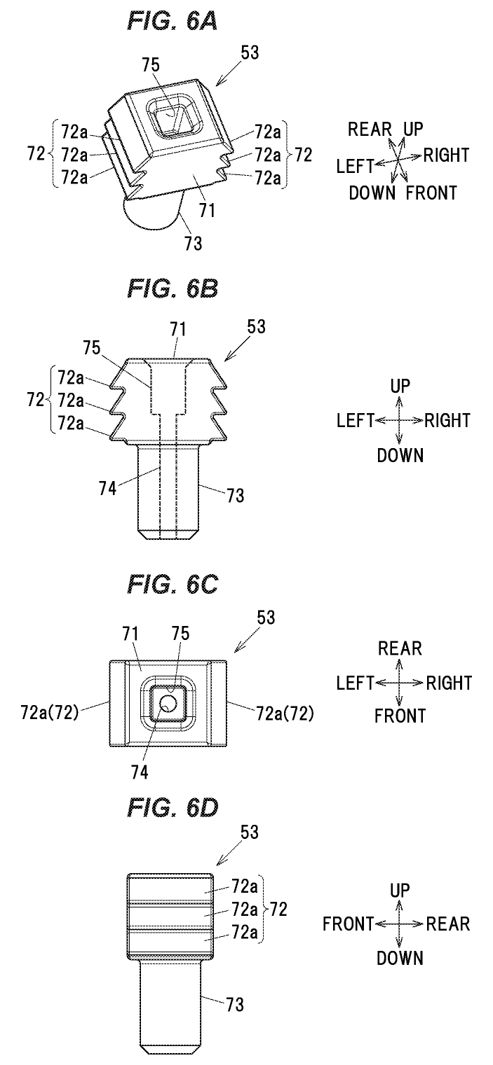

As shown in FIGS. 6A -6D, the plug 53 has a block-shaped plug main body 71, a pair of left and right engagement teeth 72, 72 that are formed on the left and right surfaces of the plug main body 71 and engage with the ratchet teeth 82 of the pair of racks 52, 52, a columnar portion 73 formed to protrude downward from the lower surface of the plug main body 71 and positioned inside the biasing spring 54, an insertion hole 74 which is formed through the plug main body 71 as well as the columnar portion 73 and through which the descending-side wire 14 is inserted, and a rectangular hole-shaped wire end fixing portion 75 which is formed at the upper end portion of the insertion hole 74 and to which a wire end 14a formed at an end of the descending-side wire 14 is fixed. The descending-side wire 14 is coupled to the plug 53 by fixing the wire end 14a of the descending-side wire 14 to the wire end fixing portion 75 while inserting the descending-side wire 14 through the insertion hole 74.

The engagement teeth 72 are formed to have a shape of ratchet teeth in which three engagement claws 72a are arranged in the up-down direction. Each engagement claw 72a is configured such that a lower surface is a locked surface locked by the ratchet teeth 82 and an upper surface is an inclined guide surface that slopes outward in the left-right direction from above to below.

As shown in FIG. 4, the biasing spring 54 is composed of a coil spring, with one end locked to the bottom wall of the mechanism housing portion 51 and the other end locked to the lower surface of the plug main body 71. By biasing the plug 53 upward (in the sliding direction of the ratchet teeth 82) by the biasing spring 54, slack of the descending-side wire 14 coupled to the plug 53 is absorbed.

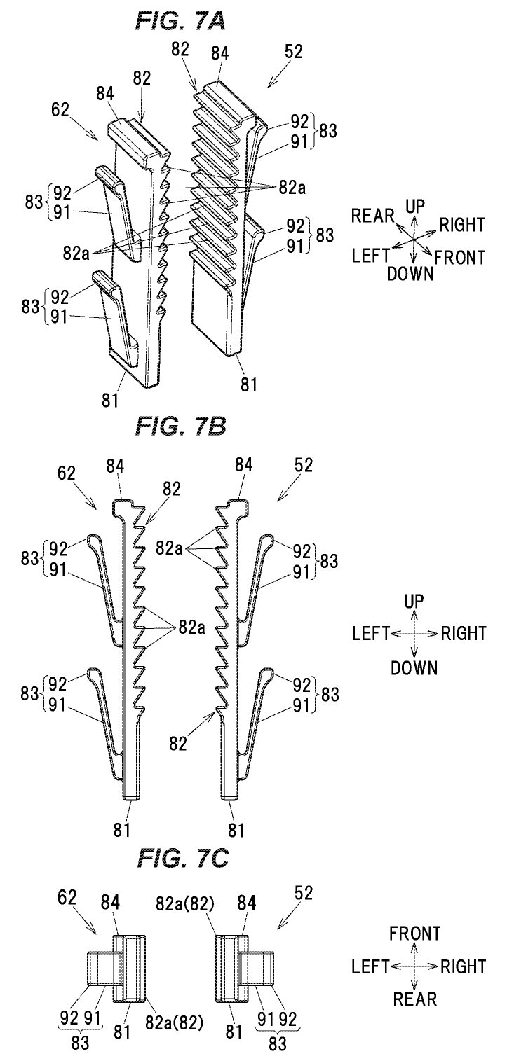

As shown in FIG. 7, each of the pair of racks 52 and 52 has a plate-shaped rack main body 81, the ratchet teeth 82 formed on a side surface of the rack main body 81 on the inner side in the left-right direction, two upper and lower plate spring portions 83 formed on a side surface of the rack main body 81 on the outer side in the left-right direction, and a pressure-receiving portion 84 formed at the upper end of the rack main body 81 and pressed when attaching the rack 52. The plate spring portion 83 is an example of the “spring portion”.

The pair of ratchet teeth 82, 82 are formed to have a shape in which plural claw portions 82a are arranged in the up-down direction. An upper surface of each claw portion 82a is a locking surface which faces the lower surface of (the engagement claw 72a of) the engagement teeth 72 of the plug 53 and locks the engagement teeth 72. Then, a lower surface of each claw portion 82a is an engagement surface which is an inclined surface sloping inward in the left-right direction from below to above and engages with the upper surface (the inclined guide surface) of the engagement claw 72a of the engagement teeth 72.

In the state in which the ratchet teeth 82 of the racks 52 are engaged with the engagement teeth 72 of the plug 53, the engagement between the upper surfaces of the claw portions 82a and the lower surfaces of the engagement claws 72a causes the claw portions 82a of the pair of ratchet teeth 82, 82 to lock the engagement teeth 72 of the plug 53, thereby restricting the downward movement of the plug 53. On the other hand, when the plug 53 tries to move upward while the ratchet teeth 82 of the racks 52 are engaged with the engagement teeth 72 of the plug 53, the engagement between the lower surfaces of the claw portions 82a and the upper surfaces of the engagement claws 72a causes the rack main bodies 81 to be guided outward in the left-right direction against the biasing force of the plate spring portions 83, thereby allowing the plug 53 to move upward. In this manner, the sliding direction of the ratchet teeth 82 is upward. When the descending-side wire 14 is slacked, the biasing force of the biasing spring 54 causes the plug 53 to move upward, which changes the engagement position between the ratchet teeth 82 and the engagement teeth 72. The downward movement of the plug 53 is restricted in this state by the engagement between the ratchet teeth 82 and the engagement teeth 72, which maintains the state in which the slack of the descending-side wire 14 is absorbed.

Each plate spring portion 83 is a resin plate spring and has a body portion 91 that extends diagonally upward from a side surface of the rack main body 81 toward the outside in the left-right direction, and an engagement portion 92 formed at a tip of the body portion 91. The body portion 91 is configured to be elastically deformable so as to swing in the left-right direction.

The engagement portion 92 has a side surface that faces the inner wall of the mechanism housing portion 51 and serves as a contact surface that comes into contact with the inner wall. By the contact of the engagement portion 92 with the inner wall of the mechanism housing portion 51, each plate spring portion 83 biases the rack 52 (the rack main body 81 and the ratchet teeth 82) toward the plug 53, with this inner wall acting as a support. That is, each plate spring potion 83 serves as a rack pressing portion that presses the rack 52 against the plug 53.

In addition, the engagement portion 92 is configured such that an upper surface is a locked surface facing the locking protrusion 61 of the mechanism housing portion 51 and being locked by this locking protrusion 61, and a lower surface is an inclined guide surface that slopes inward in the left-right direction from above to below.

When each rack 52 is inserted into the mechanism housing portion 51 downward from above, the engagement between the lower surface of the engagement portion 92 of each plate spring portion 83 and each locking protrusion 61 causes each plate spring portion 83 to be guided to swing inward in the left-right direction and contract in the left-right direction, allowing each engagement portion 92 to pass over each locking protrusion 61. In this state, as insertion of each rack 52 into the mechanism housing portion 51 progresses and each engagement portion 92 passes over each locking protrusion 61, the restoring force of the plate spring portion 83 causes the plate spring portion 83 to swing outward in the left-right direction and expand in the left-right direction. As a result, the upper surface of each engagement portion 92 faces the lower surface of each locking protrusion 61, and each engagement portion 92 is locked to each locking protrusion 61. The rack 52 is thereby attached to the mechanism housing portion 51. In this manner, the plate spring portion 83 constitutes an elastically deformable portion and a claw portion of the attachment structure in which the rack 52 is attached to the mechanism housing portion 51 (the carrier plate 11) by the snap-fit method, and the rack 52 is configured to be attachable to the mechanism housing portion 51 by the snap-fit method which involves insertion in the downward direction.

In addition, due to the attachment structure with the plate spring portion 83 and the locking protrusion 61, the direction of attaching the rack 52 to the mechanism housing portion 51 is a direction (the downward direction) opposite to the sliding direction of the ratchet teeth 82, and the rack 52 is configured to be attachable to the mechanism housing portion 51 by inserting in a direction opposite to the sliding direction of the ratchet teeth 82. This allows the rack 52 to be attached after assembling the plug 53 and the descending-side wire 14. That is, in the state after assembling the plug 53 and the descending-side wire 14, the rack 52 is inserted between the plug 53 and the inner wall of the mechanism housing portion 51 and is attached. At this time, since relative movement of the plug 53 to the rack 52 is in the sliding direction, the rack 52 can be inserted and attached without being obstructed by the engagement between the ratchet teeth 82 and the engagement teeth 72.

When inserting the rack 52 between the plug 53 and the inner wall of the mechanism housing portion 51, the engagement portion 92 is pressed inward in the left-right direction due to the engagement between the engagement portion 92 of the plate spring portion 83 and the locking protrusion 61, and also the rack main body 81 is pressed outward in the left-right direction due to the engagement between the ratchet teeth 82 and the engagement teeth 72. However, the plate spring portion 83 does not break or undergo plastic deformation even if these pressings occur simultaneously.

### Description of an operation of assembling the window regulator

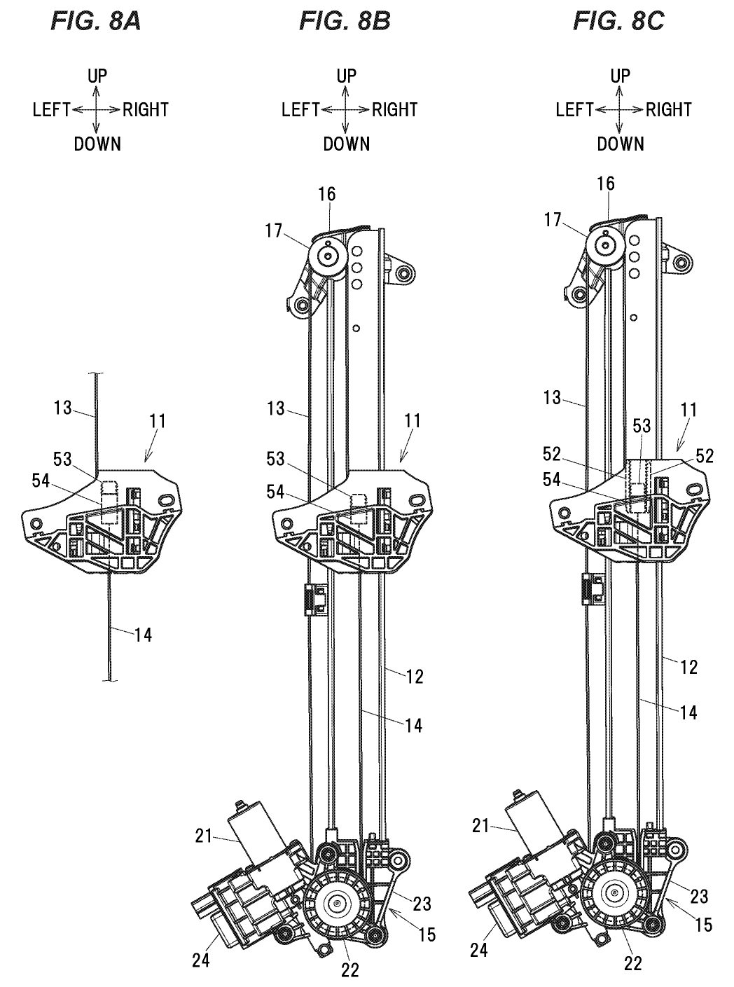

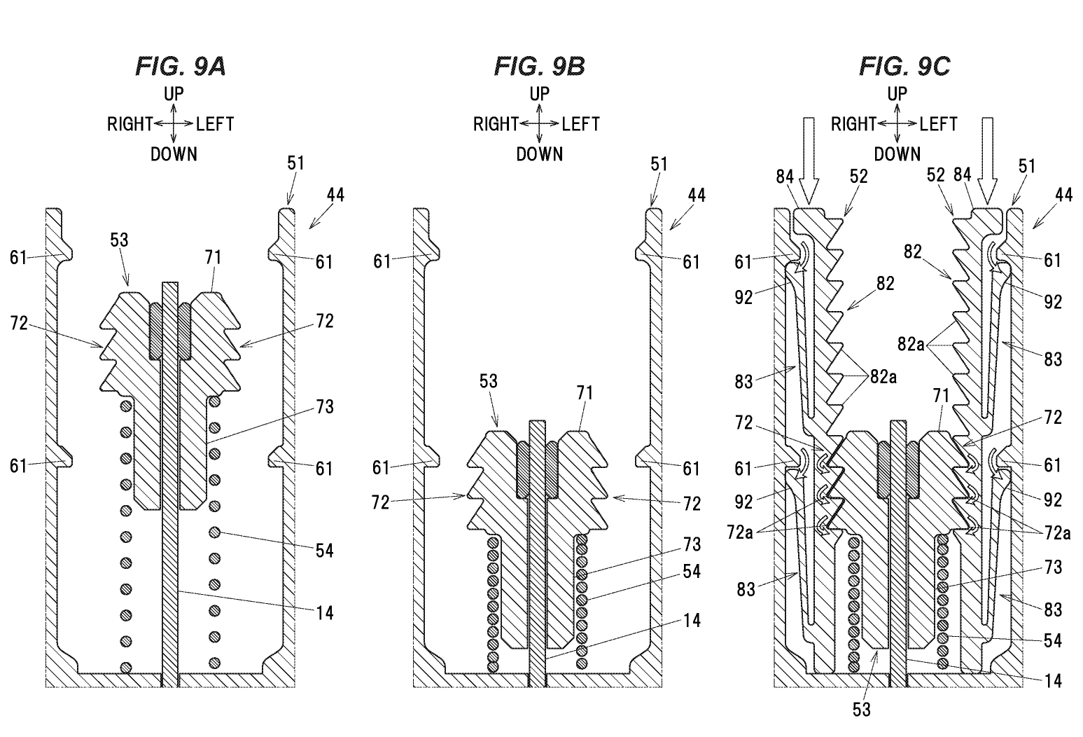

Next, an operation of assembling the window regulator 1 will be described with reference to FIGS. 8A - 9C. In the operation of assembling the window regulator, first, as shown in FIGS. 8A and 9A, the descending-side wire 14 is passed through the wire lead-out groove 55 into the carrier plate 11, and also, the plug 53 with one end of the descending-side wire 14 fixed thereto and the biasing spring 54 with the descending-side wire 14 passing therethrough are housed in the mechanism housing portion 51, thereby assembling the plug 53 and the biasing spring 54 to the carrier plate 11. After that, one end of the ascending-side wire 13 is attached to the carrier plate 11.

Next, as shown in FIG. 8B, after attaching the guide rail 12 to the drum housing 23 that houses the rotating drum 22, the carrier plate 11, the pulley bracket 16 and the pulley 17 are assembled to the guide rail 12. After that, the other ends of the ascending-side wire 13 and the descending-side wire 14 (ends on the opposite side to the carrier plate 11) are attached to the rotating drum 22 while routing the ascending-side wire 13 over the pulley 17, and then, the motor housing 24 with the motor 21 attached thereto is attached to the drum housing 23. By attaching the other end of the descending-side wire 14 to the rotating drum 22, the plug 53 is pulled by the descending-side wire 14 to cause the biasing spring 54 to be compressed as shown in FIG. 9B, and the assembly of the descending-side wire 14 is completed.

After that, as shown in FIGS. 8C and 9C, the pair of racks 52, 52 are inserted downward through the opening of the mechanism housing portion 51 and attached to the mechanism housing portion 51 by being inserted between the plug 53 and the inner wall of the mechanism housing portion 51. That is, the right rack 52 is inserted downward through the opening of the mechanism housing portion 51 and is inserted and attached between the plug 53 and the right inner wall of the mechanism housing portion 51. The left rack 52 is also inserted downward through the opening in the mechanism housing portion 51 and is inserted and attached between the plug 53 and the left inner wall of the mechanism housing portion 51. At this time, the ratchet teeth 82 of the rack 52 engage the engagement teeth 72 of the plug 53, and as the rack 52 (the rack main body 81 and the ratchet teeth 82) is guided inward in the left-right direction due to the engagement between the lower surfaces of the claw portions 82a and the upper surfaces of the engagement claws 72a, the ratchet teeth 82 move over each engagement claw 72a. In addition, due to the engagement of the lower surface of the engagement portion 92 of each plate spring portion 83 and each locking protrusion 61, each engagement portion 92 is guided inward in the left-right direction and passes over each locking protrusion 61. This allows the rack 52 to be attached to the mechanism housing portion 51 without being obstructed by the locking protrusions 61 and the engagement teeth 72.

### Functions and Effects of the embodiment

The configuration of the above embodiment can improve ease of assembly of the window regulator 1 since the rack 52 is configured to be attachable to the carrier plate 11 (the mechanism housing portion 51) by inserting in a direction opposite to the sliding direction of the ratchet teeth 82.

That is, a known window regulator is configured such that the rack 52 is first attached to the mechanism housing portion 51, and then, the plug 53, the biasing spring 54 and the descending-side wire 14 are assembled. Therefore, after assembling the plug 53 and the biasing spring 54 until completing the assembly of the descending-side wire 14 (until attaching the other end of the descending-side wire 14 to the rotating drum 22), the plug 53 moves from its initial position due to the biasing force of the biasing spring 54 and is locked in that state by the rack 52. This causes a problem that the function of eliminating slack of the descending-side wire 14 fails to work properly. For this reason, it is necessary to compress the biasing spring 54 by a person’s hand or to provide a temporary holding mechanism to compress the biasing spring 54 after assembling the plug 53 and the biasing spring 54 until completing the assembly of the descending-side wire 14.

In contrast, in the above embodiment, since it is configured such that the rack 52 can be attached by inserting into the mechanism housing potion 51 in a direction opposite to the sliding direction of the ratchet teeth 82, it is possible to insert the rack 52 between the plug 53 and the inner wall of the mechanism housing portion 51 without being obstructed by the engagement between the ratchet teeth 82 and the engagement teeth 72, hence, it is possible to attach the rack 52 after assembling the plug 53, the biasing spring 54 and the descending-side wire 14. This eliminates the need of compressing the biasing spring 54 after assembling the plug 53 and the biasing spring 54 until completing the assembly of the descending-side wire 14, hence, the window regulator 1 can be easily assembled with a simple configuration.

In addition, the configuration of the above embodiment allows the rack 52 and the plug 53 to be assembled without aligning the ratchet teeth 82 of the rack 52 with the engagement teeth 72 of the plug 53. The window regulator 1 can thereby be assembled more easily.

In addition, in the configuration of the above embodiment, since the slack removal mechanism for the descending-side wire 14 is adopted, slack of the descending-side wire 14 when occurred can be eliminated. It is thereby possible to improve the response speed of the operation of raising and lowering the window glass G.

In addition, in the configuration of the above embodiment, since the rack 52 can be attached to the carrier plate 11 (the mechanism housing portion 51) using the snap-fit method, the rack 52 can be attached more easily.

In addition, in the configuration of the above embodiment, the plate spring portion 83 constitutes the elastically deformable portion in the snap-fit attachment structure. Since the plate spring portion 83 also serves as this elastically deformable portion, the window regulator 1 can have a simpler configuration.

In addition, in the configuration of the above embodiment, the rack 52 has the pressure-receiving portion 84. Therefore, when inserting the rack 52 between the plug 53 and the inner wall of the mechanism housing portion 51, the rack 52 can be easily pushed in by pressing the pressure-receiving portion 84 with a person’s hand. This makes it easier to attach the rack 52 to the mechanism housing portion 51.

### Other embodiments

Although the embodiment of the invention has been described, the invention according to claims is not to be limited to the embodiment described above. Further, please note that not all combinations of the features described in the embodiment are necessary to solve the problem of the invention. The invention can be appropriately modified and implemented without departing the gist thereof.

For example, the configuration of the above embodiment is such that the descending-side wire attachment portion 44 has two racks 52, 52 and the plug 53 is arranged so as to be sandwiched between the two racks 52, 52, but the configuration may be such that the descending-side wire attachment portion 44 has only one rack 52.

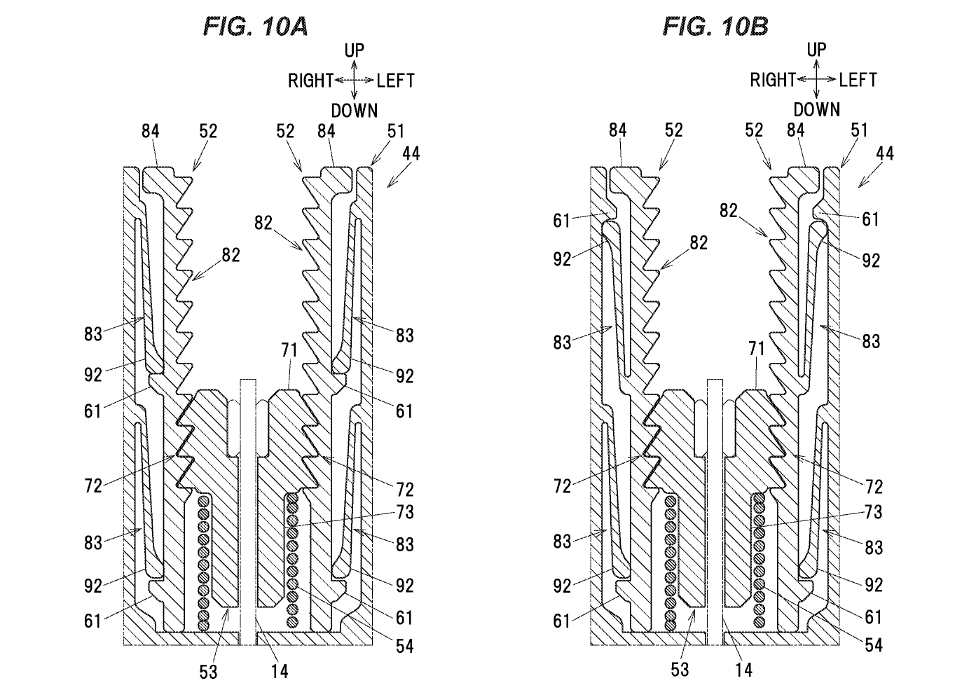

In addition, the configuration of the above embodiment is such that the plate spring portions 83 are formed on the rack 52, but the configuration is not limited thereto as long as the plate spring portions 83 are formed on one of the rack 52 and the mechanism housing portion 51 (the carrier plate 11). That is, the configuration may be such that the plate spring portions 83 are formed on the mechanism housing portion 51, as shown in FIG. 10A. Alternatively, the configuration may be such that, e.g., some of the plate spring portions 83 are formed on the rack 52 and the remaining plate spring portions 83 are formed on the mechanism housing portion 51, as shown in FIG. 10B.

In addition, the configuration of the above embodiment is such that two plate spring portions 83 are provided on a side surface of each rack 52, but the configuration may be such that only one plate spring portion 83 is provided on a side surface of each rack 52, or the configuration may be such that three or more plate spring portions 83 are provided on a side surface of each rack 52.

In addition, the configuration of the above embodiment is such that the plate spring portion 83 constitutes the elastically deformable portion and the claw portion in the snap-fit attachment structure, but the configuration is not limited thereto. That is, the configuration may be such that the descending-side wire attachment portion 44 has the elastically deformable portion and the claw portion of the snap-fit attachment structure separate from the plate spring portion 83. In such a case, the configuration may be such that the plate spring portion 83 is formed as a separate component from the rack 52 and the carrier plate 11.

In addition, the configuration of the above embodiment is such that the rack 52 is attached to the mechanism housing portion 51 using the snap-fit method, but the configuration is not limited thereto as long as the rack 52 is inserted into and attached to the mechanism housing portion 51. For example, the configuration may be such that the rack 52 is fitted into and attached to the mechanism housing portion 51.

In addition, the configuration of the above embodiment is such that a plate spring in a straight plate shape extending linearly when viewed in the front-rear direction is used as the plate spring portion 83, but a plate spring in a curved plate shape curved in an arc shape when viewed in the front-rear direction may be used as the plate spring portion 83, or it may be configured to use a plate spring in a “U” or “V” shape when viewed in the front-rear direction. Furthermore, the spring portion is not limited to the plate spring portion 83 as long as it biases the rack 52 toward the plug 53, and the configuration may be such that a coil spring, such as a torsion coil spring, is used.

In addition, the configuration of the above embodiment is such that the engagement teeth 72 include three engagement claws 72a, but the engagement teeth 72 may include any number of engagement claws 72a. That is, the configuration may be such that the engagement teeth 72 include only one or only two engagement claws 72a, or the engagement teeth 72 include not less than four engagement claws 72a.

In addition, the configuration of the above embodiment is such that the descending-side wire attachment portion 44 has the ratchet teeth 82 on the fixed-side member (the rack 52) and the engagement teeth 72 to be engaged with the ratchet teeth 82 on the movable-side member (the plug 53), but the configuration may be such that the ratchet teeth 82 is provided on the movable-side member (the plug 53) and the engagement teeth 72 on the fixed-side member (the rack 52).

In addition, the configuration of the above embodiment is such that the mechanism housing portion 51 is formed in a box shape with opening only on the upper side, but the configuration may be such that the mechanism housing portion 51 is open on the front or rear side and a cover as a separate component is attached to the front or rear side.

In addition, the configuration of the above embodiment is such that the pair of racks 52, 52 are simultaneously inserted and simultaneously attached, but the configuration may be such that one of the pair of racks 52, 52 is attached and the other rack 52 is then attached.

In addition, the invention is applied to the descending-side wire attachment portion 44 in the above embodiment, but the invention may be applied to the ascending-side wire attachment portion 45. That is, the configuration may be such that the structure of the slack removal mechanism adopted for the descending-side wire attachment portion 44 is provided on the ascending-side wire attachment portion 45.

In addition, the invention is applied to the lower end drive-type window regulator 1 having the drive unit 15 arranged at the lower end portion of the guide rail 12, but it is not limited thereto. For example, the invention may be applied to a banjo-type window regulator having the drive unit 15 arranged on the guide rail 12 at the center in the up-down direction, or the invention may be applied to a window regulator with the drive unit 15 fixed directly to (a door panel of) the vehicle door D (such as delta-type window regulator). Furthermore, the invention may be applied to a rail-less type window regulator having no guide rail 12.

### REFERENCE SIGNS LIST

1 WINDOW REGULATOR
11 CARRIER PLATE
14 DESCENDING-SIDE WIRE
44 DESCENDING-SIDE WIRE ATTACHMENT PORTION
52 RACK
53 PLUG
54 BIASING SPRING
82 RATCHET TEETH
83 PLATE SPRING PORTION
G WINDOW GLASS

1. A window regulator, comprising:
a carrier plate that supports a window glass;
a wire to pull the carrier plate; and
a slack removal mechanism that is arranged on the carrier plate and absorbs slack of the wire by moving one end of the wire,
wherein the slack removal mechanism comprises a ratchet member that is attached to the carrier plate and comprises ratchet teeth formed thereon, a movable-side member that is coupled to one end of the wire and is housed so as to be movable relative to the carrier plate while engaging the ratchet teeth, and a biasing portion to bias the movable-side member in a sliding direction of the ratchet teeth, and
wherein the ratchet member is configured to be attachable to the carrier plate by inserting in a direction opposite to the sliding direction.

2. The window regulator according to claim 1, wherein the ratchet member is configured to be attachable to the carrier plate by a snap-fit method which involves insertion in the direction opposite to the sliding direction.

3. The window regulator according to claim 2, wherein one of the ratchet member and the carrier plate comprises a spring portion to bias the ratchet member toward the movable-side member, and wherein the spring portion constitutes an elastically deformable portion of an attachment structure in which the ratchet member is attached by the snap-fit method.
